(19) United States
(12) Patent Application Publication
(10) Pub. No.: US 2025/0335987 A1
(43) Pub. Date: Oct. 30, 2025

(54) Method, System, and Non-Transitory Computer-Readable Recording Medium for Supporting Asset Transaction

(71) Applicant: Korea Securities Lending Co., Ltd., Seoul (KR)

(72) Inventor: Jae Woo HA, Seoul (KR)

(21) Appl. No.: 18/724,493

(22) PCT Filed: Apr. 18, 2023
(86) PCT No.: PCT/KR2023/005205

§ 371 Date: Dec. 16, 2024

(30) Foreign Application Priority Data
Apr. 18, 2022 (KR) 10-2022-0047843
May 11, 2022 (KR) 10-2022-0058044
Aug. 3, 2022 (KR) 10-2022-0096837

(51) Int. Cl. G06Q 40/04

(52) U.S. Cl. CPC G06Q 40/04

(57) ABSTRACT

A method of supporting an asset transaction, the method comprising: receiving, from a first trader node using an asset transaction platform, asset transaction request information that targets a second trader node not using the asset transaction platform; generating a first link to be transmitted to the second trader node with reference to the asset transaction request information; receiving, from the second trader node connected to the asset transaction platform via the first link, asset transaction acceptance information corresponding to the asset transaction request information; and confirming execution of an asset transaction between the first trader node and the second trader node with reference to the asset transaction acceptance information.

### CROSS-REFERENCE TO RELATED APPLICATIONS

The present application is the U.S. National Phase of PCT/KR2023/005205, filed on 18 Apr. 2023, which claims priority to Korean Patent Application No. 10-2022-0047843, filed on 18 Apr. 2022, Korean Patent Application No. 10-2022-0058044, filed on 11 May 2022, and Korean Patent Application No. 10-2022-0096837, filed on 3 Aug. 2022, the entire contents of which are incorporated herein by reference.

### FIELD OF THE INVENTION

The present invention relates to a method, system, and non-transitory computer-readable recording medium for supporting an asset transaction.

### BACKGROUND

Trading participants may use an electronic trading platform when trading assets such as stocks over-the-counter. However, since the electronic trading platform typically allows only users subscribed to the platform to trade assets, there occurs a problem that the trading participants cannot trade assets if they are not using the same electronic trading platform.

### SUMMARY OF THE INVENTION

One object of the present invention is to solve all the above-described problems in the prior art.

Another object of the invention is to support a normal asset transaction on a specific electronic trading platform even if any one of trading participants does not use the specific electronic trading platform.

The representative configurations of the invention to achieve the above objects are described below.

According to one aspect of the invention, there is provided a method for supporting an asset transaction, the method comprising the steps of: receiving, from a first trader node using an asset transaction platform, asset transaction request information that targets a second trader node not using the asset transaction platform; generating a first link to be transmitted to the second trader node with reference to the asset transaction request information; receiving, from the second trader node connected to the asset transaction platform via the first link, asset transaction acceptance information corresponding to the asset transaction request information; and confirming execution of an asset transaction between the first trader node and the second trader node with reference to the asset transaction acceptance information.

According to another aspect of the invention, there is provided a system for supporting an asset transaction, the system comprising: a first reception unit configured to receive, from a first trader node using an asset transaction platform, asset transaction request information that targets a second trader node not using the asset transaction platform; a generation unit configured to generate a first link to be transmitted to the second trader node with reference to the asset transaction request information; a second reception unit configured to receive, from the second trader node connected to the asset transaction platform via the first link, asset transaction acceptance information corresponding to the asset transaction request information; and an asset transaction management unit configured to confirm execution of an asset transaction between the first trader node and the second trader node asset transaction acceptance with reference to the information.

In addition, there are further provided other methods and systems to implement the invention, as well as non-transitory computer-readable recording media having stored thereon computer programs for executing the methods.

According to the invention, it is possible to support a normal asset transaction on a specific electronic trading platform even if any one of trading participants does not use the specific electronic trading platform.

### BRIEF DESCRIPTION OF THE DRAWINGS

FIG. 1 schematically shows the configuration of an entire system for supporting an asset transaction according to one embodiment of the invention.

FIG. 2 specifically shows the internal configuration of a support system according to one embodiment of the invention.

### DETAILED DESCRIPTION OF THE PREFERRED EMBODIMENTS

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

The term “asset” herein should be understood as the broadest concept encompassing all objects with economic values, such as financial assets (e.g., securities), non-financial assets (e.g., real estates), and other assets (e.g., virtual currency, points, and mileage).

Further, the term “asset transaction platform” herein may refer to a platform built to enable electronic over-the-counter asset transactions, such as an over-the-counter financial trading platform or an over-the-counter virtual currency trading platform.

Hereinafter, various preferred embodiments of the invention will be described in detail with reference to the accompanying drawings to enable those skilled in the art to easily implement the invention.

### Configuration of the Entire System

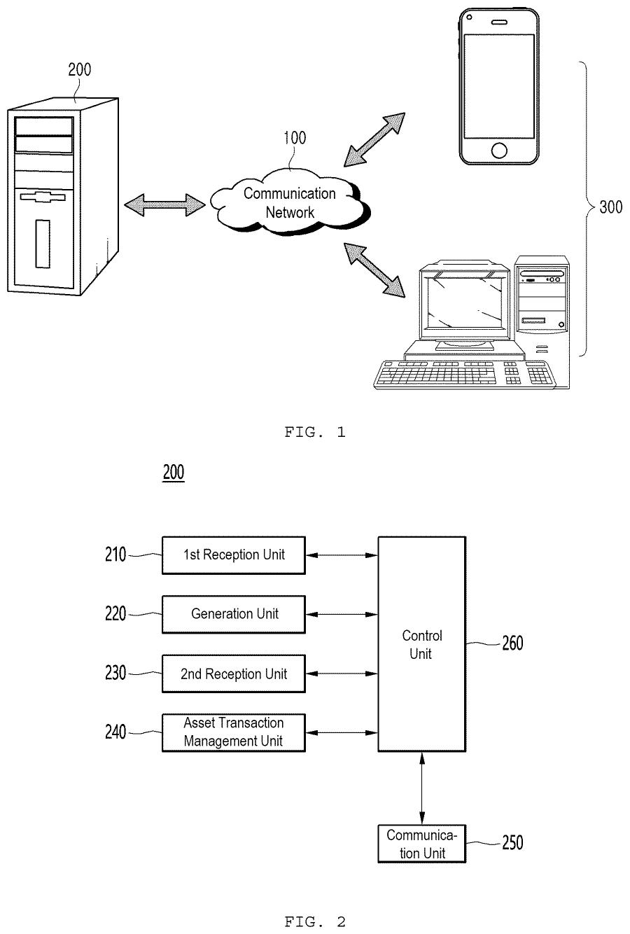

FIG. 1 schematically shows the configuration of the entire system for supporting an asset transaction according to one embodiment of the invention.

As shown in FIG. 1, the entire system according to one embodiment of the invention may comprise a communication network 100, a support system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network 100 may be an optical communication network, at least a part of which may be implemented with a conventional communication scheme such as LiFi (Light Fidelity).

Next, the support system 200 according to one embodiment of the invention may communicate with the device 300 to be described below via the communication network 100, and may function to: receive, from a first trader node using an asset transaction platform, asset transaction request information that targets a second trader node not using the asset transaction platform; generate a first link to be transmitted to the second trader node with reference to the asset transaction request information; receive, from the second trader node connected to the asset transaction platform via the first link, asset transaction acceptance information corresponding to the asset transaction request information; and confirm execution of an asset transaction between the first trader node and the second trader node with reference to the asset transaction acceptance information. Meanwhile, the support system 200 may be digital equipment having a memory means and a microprocessor for computing capabilities, and may be, for example, a server system operating on the communication network 100.

The configuration and functions of the support system 200 according to one embodiment of the invention will be discussed in detail below.

Next, the device 300 according to one embodiment of the invention is digital equipment capable of connecting to and then communicating with the support system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDAs), a web pad, and a mobile phone, may be adopted as the device 300 according to the invention.

Further, according to one embodiment of the invention, the device 300 may further include an application program for performing the functions according to the invention. The application may reside in the device 300 in the form of a program module. The characteristics of the program module may be generally similar to those of a reception unit 210, a generation unit 220, a second reception unit 230, an asset transaction management unit 240, a communication unit 250, and a control unit 260 of the support system 200 to be described below. Here, at least a part of the application may be replaced with a hardware device or a firmware device that may perform a substantially equal or equivalent function, as necessary.

### Configuration of the Support System

Hereinafter, the internal configuration of the support system 200 crucial for implementing the invention and the functions of the respective components thereof will be discussed.

FIG. 2 specifically shows the internal configuration of the support system 200 according to one embodiment of the invention.

As shown in FIG. 2, the support system 200 according to one embodiment of the invention may comprise a first reception unit 210, a generation unit 220, a second reception unit 230, an asset transaction management unit 240, a communication unit 250, and a control unit 260. According to one embodiment of the invention, at least some of the first reception unit 210, the generation unit 220, the second reception unit 230, the asset transaction management unit 240, the communication unit 250, and the control unit 260 of the support system 200 may be program modules to communicate with an external system (not shown). The program modules may be included in the support system 200 in the form of operating systems, application program modules, or other program modules, while they may be physically stored in a variety of commonly known storage devices. Further, the program modules may also be stored in a remote storage device that may communicate with the support system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the support system 200 has been described as above, and it will be apparent to those skilled in the art that at least a part of the components or functions of the support system 200 may be implemented in the device 300 or a server (not shown) or included in an external system (not shown), as necessary.

Further, the support system 200 may be a system for implementing the above-described asset transaction platform, and thus may itself be referred to as an asset transaction platform. However, it is noted that in some cases, the support system 200 and the asset transaction platform may be referred to as if they are different components.

First, the first reception unit 210 according to one embodiment of the invention may receive, from a first trader node using an asset transaction platform, asset transaction request information that targets a second trader node not using the asset transaction platform.

Specifically, according to one embodiment of the invention, a first trader node subscribed to a specific asset transaction platform may transmit asset transaction request information to the first reception unit 210 in order to execute an asset transaction (i.e., asset borrowing or asset lending) with a second trader node not subscribed to the asset transaction platform. Here, according to one embodiment of the invention, the asset transaction request information transmitted by the first trader node to the first reception unit 210 may include a desired quantity of the transaction, a desired rate of the transaction, and the like.

Next, the generation unit 220 according to one embodiment of the invention may generate a first link to be transmitted to the second trader node with reference to the asset transaction request information received by the first reception unit 210.

Specifically, the generation unit 220 according to one embodiment of the invention may generate a first link that allows the second trader node not subscribed to the asset transaction platform to connect to the asset transaction platform. According to one embodiment of the invention, the first link may be generated in the form of a web link or the like, and may be set to be no longer valid after a predetermined period of time. Further, according to one embodiment of the invention, the first link may be generated with reference to the asset transaction request information of the first trader node so that multiple links are not duplicated.

Further, the generation unit 220 according to one embodiment of the invention may generate a first code in response to the first link being generated. Specifically, according to one embodiment of the invention, the first code may be associated with the first link. According to one embodiment of the invention, authentication may be required for the second trader node to execute an asset transaction with the first trader node after connecting to the asset transaction platform via the first link, and the second trader node may use the first code to complete the authentication. Here, according to one embodiment of the invention, the first code may be a code in the form of an OTP, but is not necessarily limited thereto.

Meanwhile, according to one embodiment of the invention, the first link generated by the generation unit 220 may be indirectly transmitted to the second trader node via the first trader node, or may be directly transmitted from the generation unit 220 (or the asset transaction platform) to the second trader node. For example, the first link may be transmitted from the generation unit 220 to the first trader node after being generated by the generation unit 220, and then transmitted from the first trader node to the second trader node. Here, the first trader node may passively transmit the first link to the second trader node using a transmission means such as web mail, web messaging, or mobile messaging. As another example, the first link may be transmitted from the generation unit 220 to the second trader node after being generated by the generation unit 220. Here, the generation unit 220 may automatically transmit the first link to the second trader node using a transmission means such as web mail, web messaging, or mobile messaging.

Meanwhile, according to one embodiment of the invention, the first code may be transmitted to the second trader node in the same manner as the first link, but may also be transmitted to the second trader node in a different manner. For example, when the first link is transmitted to the second trader node in an indirect manner, the first code may be transmitted to the second trader node in an indirect manner, or may be transmitted to the second trader node in a direct manner. As another example, when the first link is transmitted to the second trader node in a direct manner, the first code may be transmitted to the second trader node in a direct manner, or may be transmitted to the second trader node in an indirect manner.

Next, the second reception unit 230 according to one embodiment of the invention may receive, from the second trader node connected to the asset transaction platform via the first link, asset transaction acceptance information corresponding to the asset transaction request information.

Specifically, according to one embodiment of the invention, the second trader node may check the asset transaction request information (e.g., the desired quantity of the transaction and the desired rate of the transaction) of the first trader node after connecting to the asset transaction platform via the first link (specifically, after completing the authentication using the first code). According to one embodiment of the invention, when the second trader node desires to execute an asset transaction with the first trader node according to the asset transaction request information of the first trader node, the second trader node may transmit asset transaction acceptance information corresponding to the asset transaction request information of the first trader node to the second reception unit 230.

Meanwhile, according to one embodiment of the invention, when the second trader node disagrees with conditions of the asset transaction corresponding to the asset transaction request information of the first trader node, the second trader node may change the conditions and transmit the asset transaction request information back to the first trader node (specifically, the second trader node may transmit the asset transaction request information to the second reception unit 230, and the first trader node may connect to the asset transaction platform to check the asset transaction request information of the second trader node). In this case, according to one embodiment of the invention, the entity that ultimately accepts the asset transaction may be the first trader node rather than the second trader node. That is, according to one embodiment of the invention, when the first trader node desires to execute an asset transaction with the second trader node according to the asset transaction request information of the second trader node, the first trader node may transmit asset transaction acceptance information corresponding to the asset transaction request information of the second trader node to the second reception unit 230.

Next, the asset transaction management unit 240 according to one embodiment of the invention may confirm execution of an asset transaction between the first trader node and the second trader node with reference to the asset transaction acceptance information received by the second reception unit 230.

Further, after confirming the execution of the asset transaction between the first trader node and the second trader node, the asset transaction management unit 240 according to one embodiment of the invention may generate asset transaction contract information and transmit it to the first trader node and the second trader node. Here, according to one embodiment of the invention, the asset transaction contract information may include a date of execution of the asset transaction, a contract number of the asset transaction, and the like.

Meanwhile, according to one embodiment of the invention, at least one of the first trader node and the second trader node may change the conditions of the asset transaction or cancel the asset transaction after the confirmation of the execution of the asset transaction, wherein the second trader node not subscribed to the asset transaction platform may use a second link in order to change the conditions of the asset transaction or cancel the asset transaction.

Specifically, the generation unit 220 according to one embodiment of the invention may further generate a second link in addition to the above-described first link. According to one embodiment of the invention, the second link may be different from the first link, and may allow the second trader node to connect to the asset transaction platform when the second trader node desires to change the conditions of the asset transaction or cancel the asset transaction after the confirmation of the execution of the asset transaction between the first trader node and the second trader node. According to one embodiment of the invention, the second link may be generated in the form of a web link or the like, and may be transmitted to the second trader node together with the first link in response to the first link being transmitted to the second trader node, or transmitted to the second trader node at a predetermined time difference from the first link. For example, the second link may be transmitted to the second trader node after the confirmation of the execution of the asset transaction between the first trader node and the second trader node.

Further, the generation unit 220 according to one embodiment of the invention may generate a second code in response to the second link being generated. Specifically, according to one embodiment of the invention, the second code may be associated with the second link. According to one embodiment of the invention, authentication may be required for the second trader node to change the conditions of the executed asset transaction with the first trader node or cancel the asset transaction after connecting to the asset transaction platform via the second link, and the second trader node may use the second code to complete the authentication. Here, according to one embodiment of the invention, the second code may be a code in the form of an OTP, but is not necessarily limited thereto.

Meanwhile, according to one embodiment of the invention, the second link generated by the generation unit 220 may be indirectly transmitted to the second trader node via the first trader node, or may be directly transmitted from the generation unit 220 (or the asset transaction platform) the second trader node. For example, the second link may be transmitted from the generation unit 220 to the first trader node after being generated by the generation unit 220, and then transmitted from the first trader node to the second trader node. Here, the first trader node may passively transmit the second link to the second trader node using a transmission means such as web mail, web messaging, or mobile messaging. As another example, the second link may be transmitted from the generation unit 220 to the second trader node after being generated by the generation unit 220. Here, the generation unit 220 may automatically transmit the second link to the second trader node using a transmission means such as web mail, web messaging, or mobile messaging.

Meanwhile, according to one embodiment of the invention, the second code may be transmitted to the second trader node in the same manner as the second link, but may also be transmitted to the second trader node in a different manner. For example, when the second link is transmitted to the second trader node in an indirect manner, the second code may be transmitted to the second trader node in an indirect manner, or may be transmitted to the second trader node in a direct manner. As another example, when the second link is transmitted to the second trader node in a direct manner, the second code may be transmitted to the second trader node in a direct manner, or may be transmitted to the second trader node in an indirect manner.

Meanwhile, according to one embodiment of the invention, in response to the first trader node or the second trader node desiring to change the conditions of the asset transaction or cancel the asset transaction after the confirmation of the execution of the asset transaction, a notification may be provided to the counterpart node of the asset transaction. For example, in response to the second trader node desiring to change the conditions of the asset transaction or cancel the asset transaction after the confirmation of the execution of the asset transaction, a notification may be provided to the first trader node, which is the counterpart node of the asset transaction.

Further, according to one embodiment of the invention, the change of the conditions of the asset transaction or the cancellation of the asset transaction by the first trader node or the second trader node after the confirmation of the execution of the asset transaction may be confirmed response to a consent of the counterpart node of the asset transaction. For example, the change of the conditions of the asset transaction or the cancellation of the asset transaction by the second trader node after the confirmation of the execution of the asset transaction may be confirmed in response to a consent of the first trader node, which is the counterpart node of the asset transaction.

Next, the communication unit 250 according to one embodiment of the invention may function to enable data transmission/reception from/to the first reception unit 210, the generation unit 220, the second reception unit 230, and the asset transaction management unit 240.

Lastly, the control unit 260 according to one embodiment of the invention may function to control data flow among of the first reception unit 210, the generation unit 220, the second reception unit 230, the asset transaction management unit 240, and the communication unit 250. That is, the control unit 260 according to the invention may control data flow into/out of the support system 200 or data flow among the respective components of the support system 200, such that the first reception unit 210, the generation unit 220, the second reception unit 230, the asset transaction management unit 240, and the communication unit 250 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for supporting an asset transaction, the method comprising the steps of:
receiving, from a first trader node using an asset transaction platform, asset transaction request information that targets a second trader node not using the asset transaction platform;
generating a first link to be transmitted to the second trader node with reference to the asset transaction request information;
receiving, from the second trader node connected to the asset transaction platform via the first link, asset transaction acceptance information corresponding to the asset transaction request information; and
confirming execution of an asset transaction between the first trader node and the second trader node with reference to the asset transaction acceptance information.

2. The method of claim 1, wherein the first link is indirectly transmitted to the second trader node via the first trader node, or directly transmitted from the asset transaction platform to the second trader node.

3. The method of claim 2, wherein in response to the first link being transmitted to the second trader node, a second link for management of the executed asset transaction is transmitted to the second trader node together with the first link.

4. The method of claim 3, wherein the second trader node is capable of changing conditions of the executed asset transaction or canceling the executed asset transaction via the second link.

5. The method of claim 4, wherein in response to the second trader node desiring to change the conditions of the executed asset transaction or cancel the executed asset transaction, a notification is provided to the first trader node.

6. The method of claim 4, wherein the change of the conditions of the executed asset transaction or the cancellation of the executed asset transaction by the second trader node is confirmed in response to a consent of the first trader node.

7. The method of claim 1, wherein the second trader node is capable of changing conditions of the asset transaction corresponding to the asset transaction request information and transmitting the asset transaction request information back to the first trader node.

8. A non-transitory computer-readable recording medium having stored thereon a computer program for executing the method of claim 1.

9. A system for supporting an asset transaction, the system comprising:
a first reception unit configured to receive, from a first trader node using an asset transaction platform, asset transaction request information that targets a second trader node not using the asset transaction platform;
a generation unit configured to generate a first link to be transmitted to the second trader node with reference to the asset transaction request information;
a second reception unit configured to receive, from the second trader node connected to the asset transaction platform via the first link, asset transaction acceptance information corresponding to the asset transaction request information; and
an asset transaction management unit configured to confirm execution of an asset transaction between the first trader node and the second trader node with reference to the asset transaction acceptance information.

10. The system of claim 9, wherein the first link is indirectly transmitted to the second trader node via the first trader node, or directly transmitted from the asset transaction platform to the second trader node.

11. The system of claim 10, wherein in response to the first link being transmitted to the second trader node, a second link for management of the executed asset transaction is transmitted to the second trader node together with the first link.

12. The system of claim 11, wherein the second trader node is capable of changing conditions of the executed asset transaction or canceling the executed asset transaction via the second link.

13. The system of claim 12, wherein in response to the second trader node desiring to change the conditions of the executed asset transaction or cancel the executed asset transaction, a notification is provided to the first trader node.

14. The system of claim 12, wherein the change of the conditions of the executed asset transaction or the cancellation of the executed asset transaction by the second trader node is confirmed in response to a consent of the first trader node.

15. The system of claim 9, wherein the second trader node is capable of changing conditions of the asset transaction corresponding to the asset transaction request information and transmitting the asset transaction request information back to the first trader node.
